(19) United States
(12) Patent Application Publication
(10) Pub. No.: US 2020/0282244 A1
(43) Pub. Date: Sep. 10, 2020

(54) SAFETY HARNESS, SAFETY EQUIPMENT COMPRISING SAID HARNESS AND PROTECTION METHOD

(71) Applicant: ENGIE, Courbevoie (FR)

(72) Inventors: LIVREAU Florence, Courbevoie (FR); Pierre BAUMANN, Courbevoie (FR)

(21) Appl. No.: 16/761,264

(22) PCT Filed: Oct. 31, 2018
(86) PCT No.: PCT/FR2018/052705

§ 371 Date: May 4, 2020

(30) Foreign Application Priority Data
Nov. 3, 2017 (FR) 1760357

(51) Int. Cl. A62B 35/00; G01L 5/04

(52) U.S. Cl. CPC A62B 35/0018; G01L 5/101; G01L 5/047; A62B 35/0025

(57) ABSTRACT

The safety harness (30) comprises:
at least one loop (31, 32, 33, 35, 36) intended to wrap around part of the body of a user, pro vided with a sensor (37, 38, 67, 68) for measuring the tightening force exerted on said loop, each measurement sensor providing a signal representing said force;
a means (42) for comparing the value represented by the signal supplied by at least one measurement sensor with a predetermined minimum force value; and
a means (42) for indicating a tightening fault, in the event that, for at least one measurement sensor, the measured force is below the predetermined minimum force value.

In embodiments of the invention, the comparison means is configured to compare the value represented by the signal provided by at least one measurement sensor with a predetermined maximum force value, with the means for indicating a tightening fault indicating a tightening fault in the event that, for at least one measurement sensor, the measured force is greater than the predetermined maximum force value.

### TECHNICAL FIELD OF THE INVENTION

The present invention relates to a safety harness, safety equipment comprising said harness, and a protection method. It applies to the fields of worksite safety and sports safety.

### STATE OF THE ART

In the case of work at height, where wearing a safety harness is mandatory, currently the only devices known are those giving an alert if there is a fall. The prevention of accidents is therefore non-existent. The same is true for certain sports requiring a harness to be worn, such as rock-climbing and treetop adventure trails.

Document CN 106 492 368 and document JP 2015 196 590 are known; they relate to securing an anchorage, not harness tightening. Document US 2010/231402, which relates to detecting the wearing of a harness, is known.

None of the devices described in these documents make it possible to verify that a safety harness is being worn correctly by its user.

### SUBJECT OF THE INVENTION

The present invention aims to remedy all or part of these drawbacks.

To this end, according to a first aspect, the present invention relates to a safety harness comprising at least one loop intended to wrap around part of the body of a user, which comprises:
for at least one loop, a sensor for measuring the tightening force exerted on said loop, each measurement sensor providing a signal representative of said force;
a means for comparing the value represented by the signal supplied by at least one measurement sensor with a predetermined minimum force value; and
a means for indicating a tightening fault if, for at least one measurement sensor, the measured force is below the predetermined minimum force value.

Thanks to these provisions, not only is the case of a loop closing fault signaled, but also the case where a loop's tightening force is insufficient. The inventor has found that the harness wearer's life expectancy is reduced significantly when a loop's tightening force is not sufficient. The present invention therefore makes it possible to provide safety harness wearers with increased protection.

In some embodiments, the comparison means is configured to compare the value represented by the signal provided by at least one measurement sensor with a predetermined maximum force value, with a tightening fault being indicated by the means for indicating a tightening fault if, for at least one measurement sensor, the measured force is greater than the predetermined maximum force value.

Thanks to these provisions, the risks of a loop's tightening force being too great is reduced. The harness wearer is therefore protected against the risks of phlebitis.

In some embodiments, the harness that is the subject of the invention comprises a means for setting at least one predetermined force value.

Thanks to these provisions, the minimum and maximum force values can be tailored to the harness wearer, in particular to his weight, and/or to local regulations.

In some embodiments, at least one measurement sensor comprises an electrical switch that is open if there is no tightening force.

Thanks to these provisions, the harness uses no electrical power if it is not being worn.

In some embodiments, at least one measurement sensor comprises an electrical resistor that varies in the presence of a tightening force.

In some embodiments, at least one measurement sensor is a resistive force sensor or a variable-resistance conductive fabric.

Thanks to each of these provisions, the reliability of the measurement is increased and the electrical consumption is reduced.

In some embodiments, the harness that is the subject of the invention comprises a means for the remote wireless communication of an item of information representative of the state of at least one measurement sensor.

Thanks to these provisions:
the user can receive a safety fault alert on a communicating terminal;
compliance with safety instructions can be tracked; and/or
a person responsible for safety can be warned of the fault concerning the safety of the user of the equipment.

In some embodiments, the harness that is the subject of the invention comprises at least one leg strap, a loop intended to wrap around the users thigh, and at least one sensor for measuring the tightening force on said leg strap.

In some embodiments, the harness that is the subject of the invention comprises at least one shoulder strap, a loop intended to wrap around the users shoulder, and at least one sensor for measuring the tightening force on said shoulder strap.

In some embodiments, the harness that is the subject of the invention comprises a control unit connected to at least one measurement sensor by a stitched conductive thread.

Thanks to each of these provisions, the detection of a safety fault is more reliable.

According to a second aspect, the present invention relates to an item of safety equipment comprising a harness that is the subject of the invention and a fastener for engaging a lanyard, and a sensor for detecting the engagement of the fastener with the lanyard, each engagement sensor providing a signal representative of the state of the engagement sensor, the means for indicating a tightening fault being configured to signal an engagement fault concerning the fastener.

In some embodiments, the fastening means for engaging the lanyard comprises a ring, a hook and a sensor for detecting the presence of the ring in the hook.

In some embodiments, the lanyard comprises two hooks and, on each hook, a sensor for detecting the presence of a mechanical part in said hook.

In some embodiments, at least one sensor for detecting presence in a hook is a sensor detecting the modulation of an electromagnetic field by said part.

According to a third aspect, the present invention relates to a method for protecting a user wearing a harness comprising at least one loop intended to wrap around part of the body of a user, said method comprising:
a step of measuring, for at least one loop, the tightening force exerted on said loop;
a step of comparing the measured tightening force with a predetermined minimum force value; and
a step of signaling a tightening fault if the measured force is below the predetermined minimum force value.

In some embodiments, the method that is the subject of the invention also comprises:
a step of comparing the measured tightening force with a predetermined maximum force value; and
a step of signaling a tightening fault if the measured force is greater than the predetermined maximum force value.

As the advantages, aims and features of this safety equipment and this method are similar to those of the harness that is the subject of the invention, they are not repeated here.

### BRIEF DESCRIPTION OF THE FIGURES

Other advantages, aims and features of the present invention will become apparent from the description that will follow, made, as a non-limiting example, with reference to the drawings included in an appendix, in which:

FIG. 1 represents, in a front view, an item of safety equipment known from the state of the art;

FIG. 2 represents, in a front view, a particular embodiment of an item of safety equipment that is the subject of this invention;

FIG. 3 represents, in an enlarged partial view of FIG. 2, a sensor inserted into a leg strap;

FIG. 4 represents a response curve for a pressure sensor;

FIGS. 5A and 5B represent, schematically, two electronic circuits comprising a pressure sensor;

FIGS. 6A and 6B represent, schematically, effects of a voltage on a voltage sensor positioned on a shoulder strap;

FIGS. 7A and 7B represent, schematically, two electronic circuits comprising a voltage sensor;

FIG. 8 represents, in a front view, a hook equipped with a sensor for detecting engagement on an anchorage;

FIG. 9 represents, schematically, an electronic circuit comprising a photoresistor;

FIG. 10 represents, schematically, the installation of units in a particular embodiment of an item of equipment that is the subject of the invention; and

FIG. 11 represents, in the form of a logical diagram, steps in an embodiment of the method that is the subject of the invention.

### DESCRIPTION OF EXAMPLES OF REALIZATION OF THE INVENTION

The present description is given in a non-limiting way, each characteristic of an embodiment being able to be combined with any other characteristic of any other embodiment in an advantageous way.

It is now noted that the figures are not to scale.

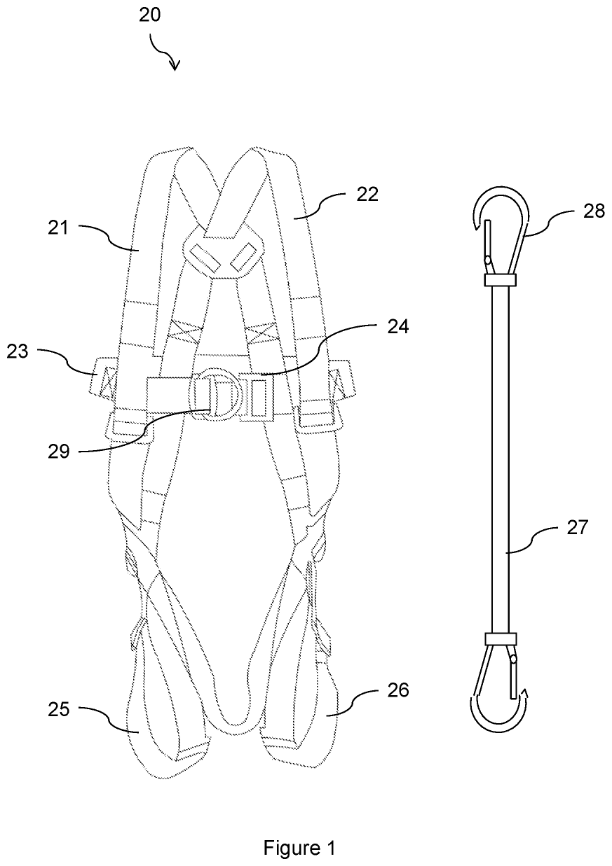

FIG. 1 shows an item of safety equipment known from the state of the art. This equipment comprises a safety harness 20. This harness 20 comprises several loops, formed from straps and intended to wrap around part of the body of a user:
shoulder straps 21 and 22;
a belt 23 closed by a closure 24; and
leg straps 25 and 26.

This harness is associated with a lanyard 27 ending in a snap hook 28 intended to be engaged in an anchor ring 29 forming a fastener for engaging the snap hook 28. The lanyard 27 comprises a second snap hook, in the bottom of FIG. 1, intended to secure the user to a tether point or to a guardrail.

FIG. 1 shows the ring 29 in an abdominal position. In other types of harness, this ring 29 is in a dorsal position.

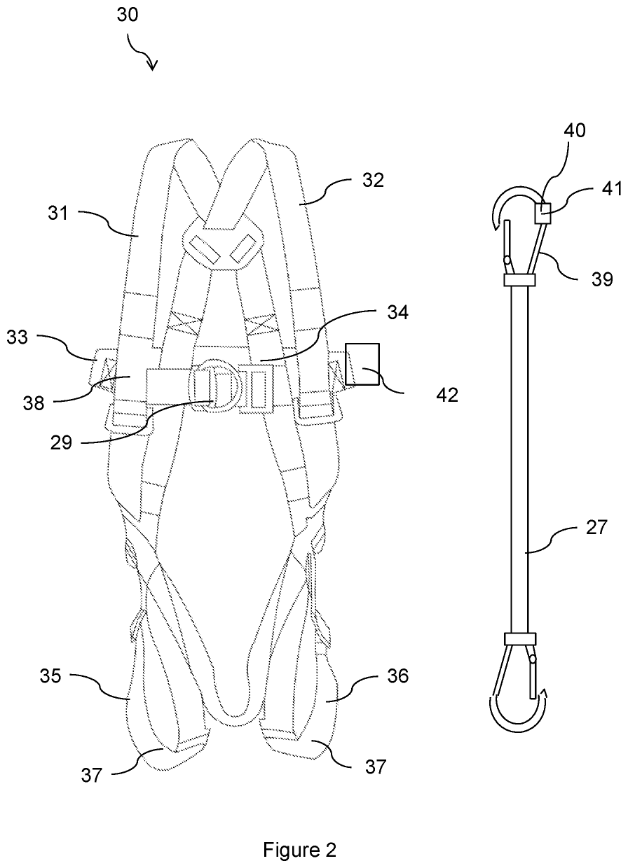

In an embodiment of the safety equipment that is the subject of the invention shown in FIG. 2, a harness 30 comprises, formed from straps, shoulder straps 31 and 32, a belt 33 closed by a closure 34, leg straps 35 and 36, and a lanyard 27 ending in a snap hook 39. Each of the leg straps 35 and 36 is equipped with a sensor 37 for measuring the tightening force. The belt 33 is equipped with a sensor 38 for measuring the tightening force on the shoulder straps. The snap hook 39 is equipped with a sensor 40 for detecting engagement on the ring 29. This engagement sensor 40 is inserted into a second control unit 41. A first control unit 42 has a wired connection via stitched conductive thread to the various sensors, 37, 38 and 40.

The safety devices—sensors and control units—of the safety harness 30 make it possible to know whether this harness 30 is positioned correctly on the user's body, the loops are tightened correctly and the restraint lanyard 27 is engaged with the ring 29.

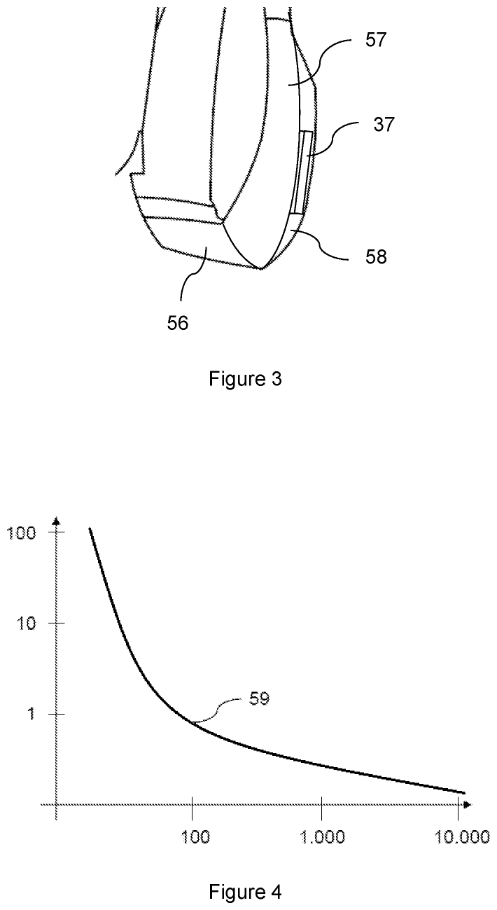

Examples of realization of the safety devices are detailed with reference to FIGS. 3 to 10.

More generally, the safety harness 30 that is the subject of the invention comprises:
at least one loop 31, 32, 33, 35 and/or 36 intended to wrap around part of the body of a user;
for at least one loop, a sensor 37 and/or 38 for measuring the tightening force exerted on said loop, each measurement sensor providing a signal representative of said force;
a means 42 for comparing the value represented by the signal supplied by at least one measurement sensor with a predetermined minimum force value; and
a means 42 for indicating a tightening fault if, for at least one measurement sensor, the measured force is below the predetermined minimum force value.

Preferably, the comparison means 42 is configured to compare the value represented by the signal provided by at least one measurement sensor with a predetermined maximum force value, with a tightening fault being indicated by the means 42 for indicating a tightening fault if, for at least one measurement sensor, the measured force is greater than the predetermined maximum force value.

Preferably, the harness comprises a means for setting at least one predetermined force value.

The means for comparing the force, signaling a tightening fault and setting force values are incorporated into the first control unit 42, with the second unit 41 performing the detection and signaling of engagement faults concerning the fastener and/or the lanyard. For the force value comparison, the first unit 42 comprises an analog-digital converter, a memory with maximum and minimum values, and a central processing unit for processing these values.

Preferably, the first and second control units 41 and 42 each comprise a wireless remote communications module for the remote transmission of an item of information representative of the state of at least one sensor. Preferably, this item of information representative of the state of at least one sensor represents changes in the state of the sensors, i.e. the closing and the measurement of the tightening force of the loops and the engagement of the snap hook 39 in the ring 29, or their loosening or disengagement, respectively. This information is received by a communicating terminal of the user and/or by a communicating terminal of a person responsible for the safety of the user. The term ‘communicating terminal’ includes in particular mobile telephones, tablets, computers, connected watches, lone worker protection (LWP) devices or lone worker alarm (LWA) devices. For clarity, an LWP or LWA is a device used by one (or more) workers “out of sight and hearing range” of other workers (e.g. in a hazardous environment, for window cleaners). It is a device that enables the emergency services to be notified if there is a problem. The call can be triggered by the LWP or LWA on a voluntary basis and/or automatically, for example in the event of the worker's loss of verticality.

The remote communication can use a short-range communications protocol, for example Bluetooth (registered trademark), which can be relayed by the communicating terminal utilizing a long-distance communications protocol, for example GSM (acronym of Global System for Mobile Communications).

The safety harness comprising the harness 30 and the lanyard 27 makes it possible to ensure that a worker working at height wears his equipment correctly (leg straps and shoulder straps tightened with a force between the two predetermined values, maximum and minimum; chest belt closed), and that the snap hook 39 of the lanyard 27 is engaged on one of the rings of the harness, for example ring 29. Optionally, the lanyard 27 comprises a second engagement sensor to notify of a possible tethering fault.

Signals, for example light, sound, or vibration signals, allow the user to be notified when the connected harness or connected lanyard is used incorrectly. These data will also be available or visible on the communicating terminal.

Thanks to this remote communication:
the user can receive a safety fault alert on a communicating terminal;
compliance with safety instructions can be tracked; and/or
a supervisor can be warned of the fault concerning the safety of the user of the harness.

The information available concerning the state of the sensors (tightening force for each measurement sensor and open/closed for each engagement sensor) can be viewed locally by visual signals as well as on a smartphone, for example, or remotely on another terminal (for example mobile telephone, tablet, personal computer, LWP lone worker protection device or connected watch).

To know whether the harness is correctly positioned and correctly tightened, and whether the restraint lanyard is installed between the harness and an attachment point, according to the invention, sensors are placed at different harness and lanyard locations.

As shown in FIG. 3, in some embodiments the harness 30 comprises, for at least one leg strap 56, a sensor 37 for measuring the tightening force on said leg strap, this sensor being a pressure sensor inserted between two parallel straps 57 and 58 of a leg strap 56. This pressure sensor 37 is, for example, an FRS (Force Sensitive Resistor) type. This sensor 37 preferably has a wired connection via stitched conductive threads to the first control unit 42.

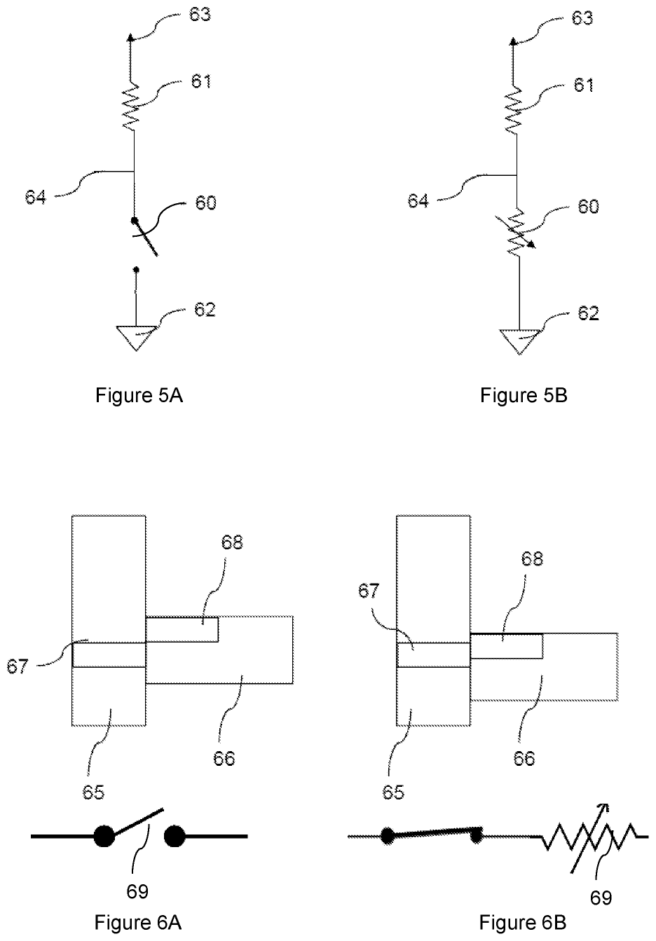

The resistance of this pressure sensor 37 varies as a function of the pressure exerted on its surface, as shown in FIG. 4. The measurement of the variation in electrical voltage applied to this variable resistor makes it possible to determine whether the user has tightened the leg strap sufficiently or too much, as shown in FIGS. 5A and 5B.

In FIG. 4, curve 59 shows the relationship between the force exerted, on the x-axis, and the resistance at the terminals of the sensor measuring the tightening force, on the y-axis. If the pressure exerted is non-existent or insufficient, the sensor 37 measuring the tightening force acts as an infinite resistor (open circuit). The terminal 63 is therefore isolated from the electrical ground and no current passes, which limits electrical consumption solely to the use of the device.

For the tightening to be sufficient (a hand must not be able to pass between the strap and the thigh), a force of about one Newton must be exerted. A voltage of approximately 0.5 V is then measured between the terminals 62 and 64 of the sensor 37, the electrical equivalent of a variable resistor 60 connected in series with a fixed resistor 61, as shown in FIGS. 5A and 5B. The use of a 10-kilohm fixed resistor 61 allows the circulating current to be limited to 0.2 mA. It is noted that this value is much lower than the first perception threshold (0.5 mA) given for the prevention of electrical hazards.

As shown in FIGS. 6A and 6B, the harness 30 comprises, for at least one shoulder strap 31 or 32, at least one sensor 38 for detecting the tightening of said shoulder strap.

In the embodiments shown in FIGS. 6A and 6B, conductive fabrics 67 and 68, positioned on straps 65 and 66 and mobile relative to each other, are used to realize the sensor 37 and/or 38 for measuring the tightening force. By evaluating the electrical continuity between these conductive fabrics, represented by the electrical resistance between these conductive fabrics, the tightening force of each shoulder strap 31 and 32 and/or of each leg strap 35 and 36 is measured.

FIG. 6A represents the case in which the shoulder strap or leg strap is not tightened: the conductive fabrics 67 and 68 are not superposed and therefore are not in contact. The electrical resistance 69 of the link between the fabrics 67 and 68, in this case equivalent to an open switch, is infinite. FIG. 6B represents the case in which the shoulder strap or leg strap is tightened: the conductive fabrics 67 and 68 are superposed and provide electrical continuity, their link 69 is thus equivalent to a variable resistor.

In some embodiments, a conductive fabric is used that is sensitive to pressure (for example, Velostat or Linqstat, registered trademarks). On each strap, this conductive fabric is stitched such that, when the corresponding shoulder strap is in place and is tightened, contact is made between two strips of conductive fabric, variable electrical resistances 70 and 74 appearing between the terminals 72 and 75.

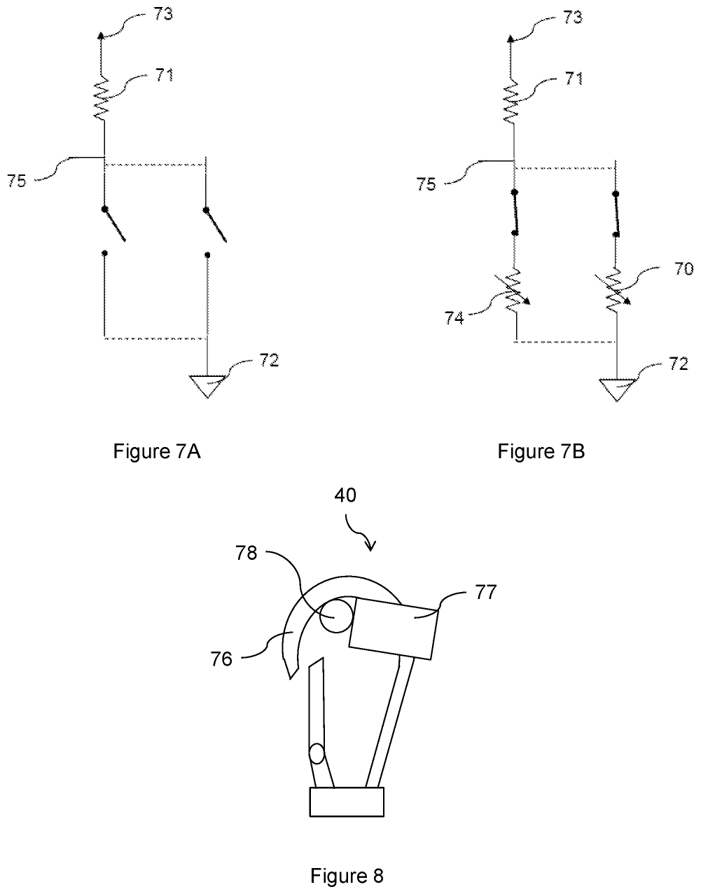

FIGS. 7A and 7B show electronic circuits for utilizing pressure-sensitive conductive fabrics, electrical equivalents of variable resistors 70 and 74. When there is no tightening, FIG. 7A, the conductive fabrics 67 and 68 are electrically equivalent to an open switch. When the harness is tightened, FIG. 7B, the conductive fabrics 67 and 68 are electrically equivalent to a variable resistor where the tighter the harness loop, the lower the electrical resistance.

For the tightening to be sufficient, a predetermined voltage, for example 0.1 V, must be measured between the terminals 72 and 75 of the sensor 38, the electrical equivalent of variable resistors 70 and 74 connected in parallel to each other, and connected together in series with a fixed resistor 71 linked to the positive pole of the electrical supply of the first control unit 42. The use of a 10-kilohm fixed resistor 71 allows the circulating current to be limited.

It is noted that, when the tightening is non-existent or insufficient, the terminal 73 is isolated from the electrical ground, as shown in FIG. 7A, and no current circulates. This limits electrical consumption solely to periods when the device is being used.

In other embodiments in which the chest belt is closed by clipping metal fasteners together, the tightening of this chest belt can be checked by using stitched conductive threads placed over the entire length of the strap forming this belt. These conductive threads connect each of the conductive fabrics 67 and 68 to the first control unit 42, with electrical continuity being provided by the metal fasteners of the belt.

With regard to the engagement sensor 40, in its embodiment shown in FIG. 8 a presence detector 77 checks that the snap hook 76 is engaged with a portion 78 of the ring 29, by means of magnetic detection. More generally, a sensor detecting presence in a hook can be a sensor detecting the modulation of an electromagnetic field (electrical, magnetic, or light) by a portion 78 of the ring 29.

In the case where each snap hook of the lanyard comprises a sensor checking its engagement on a metal part (harness ring or tether point), the electrical connections from at least one engagement sensor incorporated in a snap hook to the second control unit 41 can be realized by stitched conductive threads.

The first control unit 42 performs:
the comparison of the tightening force value represented by the signal supplied by at least one measurement sensor with a predetermined minimum force value;
the comparison of the tightening force value represented by the signal supplied by at least one measurement sensor with a predetermined maximum force value;
the notification of a tightening fault if, for at least one measurement sensor, the measured force is below the predetermined minimum force value or greater than the predetermined maximum force value.

By means of a communicating terminal, the first control unit makes it possible to set at least one predetermined force value. For example, a user interface displayed on a display screen of the communicating terminal makes it possible to assign a numerical value to each of the predetermined minimum and maximum force values. Alternatively, this user interface makes it possible to assign a value for the users weight and/or the applicable regulation, and the communicating terminal determines the minimum and maximum force values to be applied.

For the lanyard 27 shown in FIG. 2, an engagement sensor is provided at each extremity of the lanyard 27, on the harness 30 side and on the tether point side.

As the lanyard is attached to but separate from the harness, a second electronic circuit and a second control unit 41 are necessary. Like the first control unit 42, light and/or sound indications can be seen or heard by the user and sent to a communicating terminal.

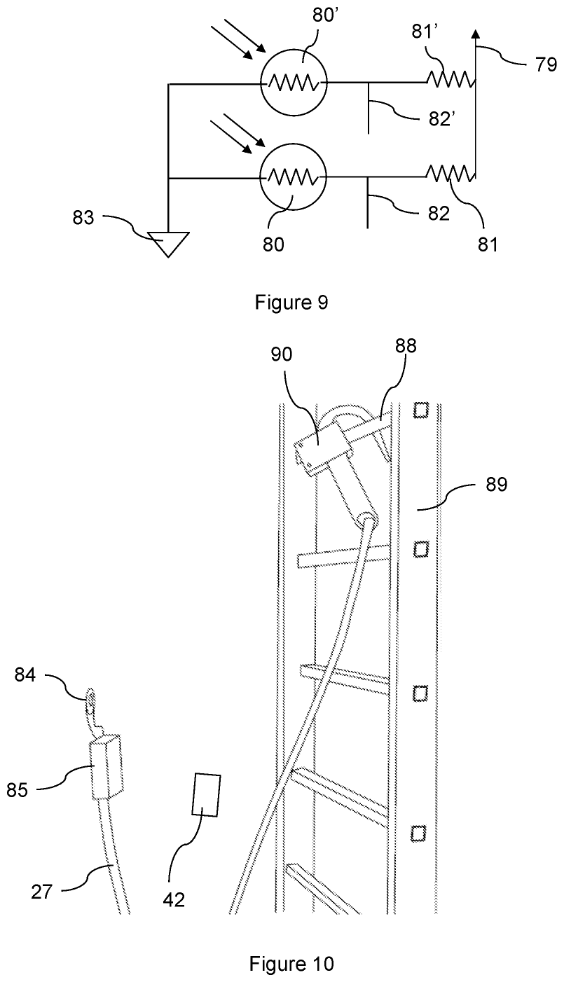

Some embodiments of the device that is the subject of the invention can be adapted to very different snap hook shapes. In some embodiments, such as that shown in FIG. 9, two photoelectric cells act as presence detector for the second control unit 41. The first measures the light intensity in the vicinity (reference value), and the second is darkened when an object is placed in the optical field of the cell. This solution ensures reliable operation even in very low light conditions. The electrical resistance of each photoelectric cell varies with the intensity of incident light. For the tethering hook, when an object (fixed point or guardrail) is present in the detection area of the second photoelectric cell, the light intensity is reduced on the second photoelectric cell and the difference between the signal emitted by the second photoelectric cell and the signal emitted by the first photoelectric cell indicates that the lanyard is correctly positioned.

FIG. 9 shows an electronic circuit in the case where a photoresistor 80 is used to detect the presence of a portion 78 of the ring in the snap hook 76. The electrical resistance, variable with the incident illumination, of the photoresistor 80 is measured by connecting it in series with a fixed electrical resistor 81, for example of 10 kilo ohms, between the terminals 79 and 83 of the electrical supply, the measurement being made at terminals 82 and 83 of the photoresistor 80.

Preferably, as shown in FIG. 9, the ambient light level measured with a complementary photoresistor 80′ in series with a fixed electrical resistor 81′, and the light level in front of an obstacle (in our case the anchor point) are compared. The photoresistors 80 and 80′ are identical but positioned in different locations so that the illumination of the photoresistor 80′ is not affected by the anchoring of the hook. The electrical resistors 81 and 81′ are the same.

If the two measurements made at the terminals 82 and 82′ are close, for example a difference of less than twenty-five percent, this indicates that the hook is not positioned on the anchor point. Conversely, if the two measurements are very different, this indicates that the hook is positioned in front of an obstacle (ladder rung, anchor point, guardrail). This comparison makes it possible to avoid false alerts linked to variations in the ambient light conditions.

FIG. 10 partially illustrates an embodiment of the harness that is the subject of the invention, comprising a dorsal ring 84, an energy absorber 85, a lanyard 27, a first unit 42, a tethering hook 88 for fastening on a tether point 89, and a third unit 90, similar to the second unit 41.

It is noted that, ideally, when the harness is not correctly positioned on the user or is removed intentionally in a hazardous area, the person responsible for worksite safety must be informed of this, in addition to the user.

It is not always possible to ensure that the lanyard is connected to a reliable attachment point. The user might circumvent the proximity detector, for example by attaching a strap with the lanyard connector. To overcome this problem, in some embodiments there is an electronic tag at each of the predefined fixed tether points, and an electronic tag reader is incorporated in the second electronic control unit 41 of the lanyard 27. The presence of an electronic tag guarantees that the connector of the lanyard is positioned on a fixed tether point. For the guardrails (taut cables), this solution would only be applicable if the guardrail transports an identification signal, for example by forming an antenna. In some embodiments, a magnetized part is placed at the disconnect point of the guardrail, the magnetization being detected by the engagement sensor to confirm the disconnection.

Therefore, in embodiments where one wants to prevent the user from being able to place a dummy object in the snap hook, an identifier can be positioned on the tether point or guardrail, for example a label or an electronic tag, and an identifier reader can be incorporated in the engagement sensor positioned on the inside of the snap hook of the restraint lanyard, with a controller verifying the identifier read in this way. In the case of an electronic tag, a communication protocol such as RFID (Radio Frequency Identification) can be utilized.

Each control unit of the harness and lanyard comprises, for example:
a microcontroller board, which manages the sensors;
a remote communication board, for example using the Bluetooth (registered trademark) protocol, which transfers information to a communicating terminal;
an electrical power supply, for example using a cell or battery recharged through a connector, for powering the boards of the unit; and
a local alarm device (sound, light, or vibration).

As the harness that is the subject of the invention is used outdoors, the unit preferably has a water splash protection class of at least IP67 and impact resistance at least equal to IK8 class, compatible with on-site working. If used in an explosive atmosphere, the unit needs to be ATEX-certified.

The unit is preferably permanently fastened to the harness, as opposed to a removable fastening. On the harness, the measurement sensors make it possible to control the tightening force of the leg straps, shoulder straps and the closure of the chest belt. The incorporation of pressure sensors poses no specific problems with certain harnesses that have double straps or a single strap covered with a comfort material (e.g. foam), for example by placing the pressure sensor between two straps.

To check the closure of the chest strap, depending on its type, the following is provided, for example: for clip closures, the sensor described above; for quick-release closures, a contact similar to the contacts used in car seat belts; for snap hook closures, a magnetic or optical sensor.

In some variants not shown, the second control unit 41 and/or the third unit 90 of the restraint lanyard is connected to the first control unit 42 of the harness by a wireless connection. The restraint lanyard can be mechanically linked to the harness by a dorsal fastening point 84 of the harness (as shown in FIG. 10), an abdominal fastening point of the harness, or a lateral fastening point of the harness.

To make sure that the user observes the various safety measures, a control system, provided for a crew manager, enables the crew manager to be informed of the state of the various sensors on the harness and on the restraint lanyard.

Preferably, the alarm signals sent to the user are sound, light, or vibration signals at the location of the monitoring units and/or at the communicating terminal.

Preferably, to avoid having alarms triggered when, for example, the user changes lanyard to carry out his task, a device allows the user to indicate a deliberate uncoupling of the lanyard. An electronic tag on the abdominal loop can be used for this purpose. When the user moves, he places the snap hook 39 on the abdominal loop. An electronic tag could be positioned there, which would be identified as an “authorized point”.

In some embodiments not shown, the communicating terminal performs additional useful functions related to the safety of the user such as, if supported by the data exchange protocol, connecting to other personal protection equipment (PPE), image capture, access control, monitoring the outside temperature, monitoring for the loss of wireless links, noise measurement, and/or LMRA (Last Minute Risk Analysis).

In some embodiments, instead of stitched conductive threads, a harness is used that comprises conductive textiles, for example comprising graphene or carbon nanotubes. The harness structure is therefore conductive. In some embodiments, the pressure or voltage sensors comprise nano-LED light barriers, magnetic sensors, or ultrasonic sensors.

Other types of sensor can be utilized to check the position and correct tightening of the harness or the fastening of the lanyard on the harness or tether point. For example, sensors for:
measuring an angle;
measuring mechanical stress;
measuring a current;
measuring an electrical or magnetic field;
measuring a flow rate;
measuring displacement;
measuring distance;
measuring force;
measuring inertia;
measuring luminosity;
measuring levels;
measuring position;
measuring pressure;
measuring sound frequency or intensity;
measuring temperature;
measuring electrical voltage;
measuring physical tension.

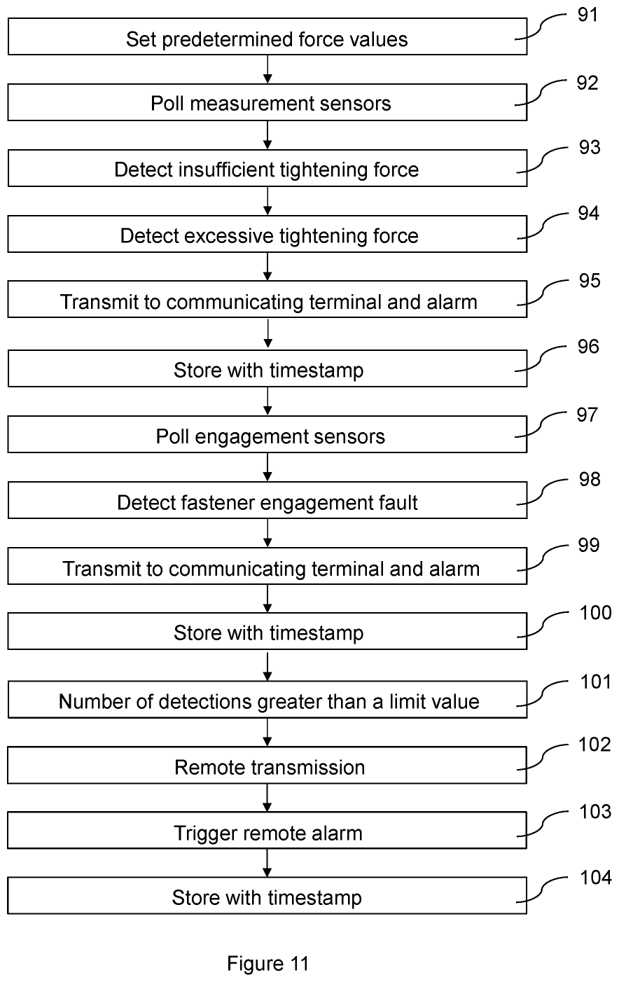

As shown in FIG. 11, in some embodiments the method for protecting a user wearing a harness that is the subject of the invention comprises:
a step 91 of setting at least a predetermined minimum force value and, optionally, a predetermined maximum force value;
a step 92 of capturing, for at least one loop, the measurement of the tightening force on said loop;
a step 93 of comparing the measured force represented by the signal coming from the measurement sensor with a predetermined minimum force value;
a step 94 of comparing the measured force represented by the signal coming from the measurement sensor with a predetermined maximum force value;
   and, if the measured force is below the predetermined minimum force or the predetermined maximum force:
a step 95 of transmitting to a user communicating terminal an item of information representative of a tightening fault, and of triggering a local alarm on said terminal; and
a step 96 of storing the timestamped information representative of the tightening fault.

The method also comprises:
a step 97 of detecting, for the fastening means, the fasteners engagement with a lanyard;
a step 98 of detecting an engagement fault, as a function of the signal provided by the engagement sensor; and, if an engagement fault has been detected:
a step 99 of transmitting to a user communicating terminal an item of information representative of an engagement fault, and of triggering a local alarm on said terminal; and
a step 100 of storing the timestamped information representative of the fault.

Should at least one tightening fault, below the predetermined minimum value or greater than the predetermined maximum value, or an engagement fault be detected, the method also comprises:
a step 101 of counting the number of faults detected and of comparing this number with a predetermined limit value, for example five, during a predetermined length of time, for example five minutes;
if the number of faults is greater than the limit value, a step 102 of transmitting to a supervisor communicating terminal an item of information representative of this limit value being exceeded;
a step 103 of triggering an alarm at the location of this supervisor communicating terminal; and
a step 104 of storing, with timestamp, the triggering of this alarm.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A safety harness comprising at least one loop intended to wrap around part of the body of a user, which comprises:
for at least one loop, a sensor for measuring the tightening force exerted on said loop, each measurement sensor providing a signal representative of said force;
a comparator for comparing the value represented by the signal supplied by at least one measurement sensor with a minimum predetermined force value; and
an indicator for indicating a tightening fault, in the event that, for at least one measurement sensor, the measured force is below the minimum predetermined force value.

18. The harness according to claim 17, wherein the comparator compares the value represented by the signal provided by at least one measurement sensor with a predetermined maximum force value, with a tightening fault being indicated by the indicator of a tightening fault if, for at least one measurement sensor, the measured force is greater than the predetermined maximum force value.

19. The harness according to claim 17, which comprises a control unit for setting at least one predetermined force value.

20. The harness according to claim 17, wherein at least one measurement sensor comprises an electrical switch that is open if there is no tightening force.

21. The harness according to claim 17, wherein at least one measurement sensor comprises an electrical resistor that varies in the presence of a tightening force.

22. The harness according to claim 17, wherein at least one measurement sensor is a resistive force sensor or a variable-resistance conductive fabric.

23. The harness according to claim 17, which comprises a remote wireless communication unit communicating an item of information representative of the state of at least one measurement sensor.

24. The harness according to claim 17, which comprises at least one leg strap, a loop intended to wrap around the user's thigh, and at least one sensor for measuring the tightening force on said leg strap.

25. The harness according to claim 17, which comprises at least one shoulder strap, a loop intended to wrap around the user's shoulder, and at least one sensor for measuring the tightening force on said shoulder strap.

26. The harness according to claim 17, which comprises a control unit connected to at least one measurement sensor by a stitched conductive thread.

27. A safety equipment comprising a harness according to claim 17 and a fastener for engaging a lanyard, and a sensor for detecting the engagement of the fastener with the lanyard, each engagement sensor providing a signal representative of the state of the engagement sensor, the indicator of a tightening fault being configured to signal an engagement fault concerning the fastener.

28. The safety equipment according to claim 27, wherein the fastener for engaging the lanyard comprises a ring, a hook and a sensor for detecting the presence of the ring in the hook.

29. The safety equipment according to claim 28, wherein the lanyard comprises two hooks and, on each hook, a sensor for detecting the presence of a mechanical part in said hook.

30. The safety equipment according to claim 28, wherein at least one sensor for detecting presence in a hook is a sensor detecting the modulation of an electromagnetic field by said part.

31. A method for protecting a user wearing a harness comprising at least one loop intended to wrap around part of the body of a user, said method characterized in that it comprises:
measuring, for at least one loop, the tightening force exerted on said loop;
comparing the measured tightening force with a predetermined minimum force value; and
signaling a tightening fault if the measured force is below the predetermined minimum force value.

32. The method according to claim 31, which further comprises:
comparing the measured tightening force with a predetermined maximum force value; and
signaling a tightening fault if the measured force is greater than the predetermined maximum force value.
